(19) United States
(12) Patent Application Publication
(10) Pub. No.: US 2026/0294599 A1
(43) Pub. Date: Oct. 1, 2026

(54) Method for Producing a Partial Dental Prosthesis Comprising a Carrier Structure

(71) Applicant: Kulzer GmbH, Hanau (DE)

(72) Inventors: Frank-Uwe Stange, Langenargen (DE); Matthias Moeller, Eriskirch (DE); Karl-Heinz Renz, Elsenfeld (DE)

(21) Appl. No.: 19/475,924

(22) PCT Filed: Apr. 12, 2024
(86) PCT No.: PCT/EP2024/059988

§ 371 Date: Oct. 16, 2025

(30) Foreign Application Priority Data
Apr. 17, 2023 (DE) 10 2023 109 570.6

(51) Int. Cl. A61C 13/00; A61C 13/10; A61C 13/34

(52) U.S. Cl. CPC A61C 13/0027; A61C 13/0004; A61C 13/0022; A61C 13/1003; A61C 13/34

(57) ABSTRACT

The invention relates to a method for producing a partial dental prosthesis using CAD models, comprising:
generating each model of prosthetic teeth, a prosthetic base, and a carrier structure;
producing the carrier structure in a digital or analog manner;
producing a connecting surface in a milling body;
arranging the carrier structure on the connecting surface; introducing a fluid polymerizable plastics material into the volume removed in the surface of the milling body;
curing or partially curing the plastics material; and
subtractively machining the polymerized plastics material and the milling body using a CAM method.

The invention also relates to a partial dental prosthesis producing using such a method and to a device for implementing such a method.

The invention relates to a method for producing a partial dental prosthesis, the partial dental prosthesis comprising at least one prosthetic tooth, a prosthetic base, and a carrier structure, the prosthetic base comprising a gum-colored plastics material, and to such a partial dental prosthesis produced using such a method as well as to a device for producing such a partial dental prosthesis comprising a carrier structure.

Partial dental prostheses, also called partial dental prosthetic dentures, are used to supplement the remaining existing teeth. In addition to the tooth-colored and gum-colored portions of the partial prostheses, a carrier structure in the form of a support structure or holding structure or in the form of a supporting component of the functional elements is additionally required. Conventionally, metal model castings are used, for example, to which prosthetic plastics material and prosthetic teeth are joined in the analog method.

In addition to manual techniques, digital manufacturing methods are becoming increasingly significant in the dental sector. Dentures, for example dental prostheses (partial prostheses and full prostheses), crowns, bridges, and occlusal splints, have for some years been produced by means of computer-aided design/computer-aided manufacturing (CAD/CAM) technologies using subtractive milling methods. CAD/CAM methods are increasingly also used in the production and design of partial and full dental prostheses with a prosthetic base for lying against the gingiva and prosthetic teeth fastened or arranged therein.

Digital methods allow for the production of the carrier structures by means of subtractive manufacturing methods, e.g. milling methods, or additive manufacturing methods, e.g. sintering processes. Likewise, tooth-colored or gum-colored elements can be digitally prefabricated.

For the purposes of digital design of prosthetic work, in particular of partial or full dental prostheses, the structure can be divided into a “white” or tooth-colored tooth portion (the prosthetic tooth or prosthetic teeth) and a gum-colored (“pink”) prosthetic base portion (the prosthetic base). Partial dental prostheses therefore consist of a gum-colored or pink prosthetic base and tooth-colored portions (prosthetic tooth, prosthetic teeth, or tooth segments).

There are methods, for example the methods known from DE 10 2009 056 752 A1 or WO 2013/124 452A1, in which a partial or full dental prosthesis is waxed up digitally and produced by means of CAD/CAM methods. Patent DE 103 04 757 B4 discloses a method for producing dentures in which the prosthetic teeth are virtually waxed up in a virtual model and a prosthetic base is produced on the basis of the virtual model. EP 2 742 906 A1 discloses a method in which a dental arch is connected to an impression composition, wherein the impression composition is held in an individualized impression tray and contains an impression of the situation in the patient's oral cavity. The surface of the mold with the dental arch is digitized and then a virtual model of the dental arch is computationally positioned and oriented with the best possible fit in the virtual model of the prosthetic base.

For the purposes of digital total prosthetics or partial prosthetics, prosthetic teeth or dental moldings are required which can be clearly and reproducibly adhesively bonded to the prosthetic base.

US 2021/205055 A1 discloses a method for producing removable dentures, which are manufactured in different parts which are interconnected by a frame. WO 2020/178195 A1 discloses a method for producing a dental molding in which key structures are used for clear relative positioning in order to produce multi-colored dental moldings. WO 2023/088831A1 , which was not previously published, discloses a computer-implemented method for providing a jig for a casting matrix, which is provided for casting one or more artificial gum parts of a removable prosthesis. The casting matrix comprises recesses, the shape of which is a negative of a 3D geometric form of a detail of the removable dentures with one of the artificial gum parts to be cast.

WO 2016/091 762 A1 discloses a method for producing a dental prosthesis, in which a jig is produced with which a plurality of prosthetic teeth may be fastened in the desired location and orientation relative to one another on a prosthetic base. In this case, the prosthetic teeth are shortened by basal grinding in a cervical region, to achieve the desired occlusal height. WO 2016/110 392 A1 discloses a method for producing a dental prosthesis, in which a plastically deformable connecting means is introduced into dental alveoli of a prosthetic base in order to enable manual correction of the orientation of the prosthetic teeth in the prosthetic base. DE 10 2008 019 694 B3 discloses a method and an apparatus for producing dental moldings from ceramics with a laser. EP 2 571 451 B1 and EP 2 666 438 A2 disclose methods for producing dental prostheses in which prefabricated prosthetic teeth are embedded in a wax mount and then milled away cervically by means of CAM methods. It is necessary to shorten the prosthetic teeth basally (or cervically) in order to adapt the tooth height to the patient's jaw, i.e. to tailor the occlusal height of the dental prosthesis to the patient's requirements. WO 2014/159 436 A1 discloses a coated dental prosthesis having a reinforcement in the prosthetic base, which is cast into a basal cavity.

Both in additive and subtractive manufacturing, the connection of the prosthetic base and tooth-colored portions (prosthetic teeth) is a significant challenge. A critical aspect is therefore still the connection of the digitally manufactured parts to one another, in particular also in terms of the precision of the arrangement relative to one another. Adhesive bonding, also using positioning aids such as fixing keys, always results in some level of misalignment which needs to be corrected by the treatment personnel. The connection is generally made by adhesive bonding, in which the quality of the transitions owing to the use of too little or too much adhesive and the correct positioning of the prosthetic teeth during adhesive bonding are both prone to error. While one-part, two-colored (gum-colored and tooth-colored) milling blanks, which are also available, do have a very good connection between the layers, the aesthetics are always a compromise and so unsatisfactory due to the predetermined phase boundaries.

In the prior art, there are the following options for producing digitally designed partial dental prostheses: 1. Milling or sintering the carrier structures, milling or printing the prosthetic base and/or prosthetic teeth (tooth-colored portions) with subsequent analog adhesive bonding of the parts on one hand and 2. fully analog design of the framework structures on the model, production of a metal model casting with completion on the model on the basis of waxing up the functional regions.

US 2013/0101962 A1 discloses a method for producing a dental prosthesis, wherein, in the method, a plurality of indentations are milled in a block along a dental arch, wherein a plurality of plastics materials are introduced into the indentations and, in the meantime, the prosthetic teeth are manufactured from the plastics materials cured in the indentations. The block is then largely machined away and the prosthetic base is manufactured from the block.

The method is a multi-stage milling method. Drawbacks of the method according to US 2013/0101962 A1 include the high material loss and the time required to machine away the material of the block, as well as the wear to the tools required for this purpose. A carrier structure is not provided and has to be additionally attached to the prosthetic base, as in analog methods. EP 2 915 503 B1 discloses a reverse method for producing a dental prosthesis in which a milling blank is subtractively machined from a dental enamel material in order to generate a cavity which is used as a negative shape for a prosthetic base of a dental prosthesis. The occlusal side and the basal side of the dental prosthesis are then subtractively produced from the resulting composite. This is also a multi-stage milling method. A drawback of the method according to EP 2 915 503 B1 can be that very large quantities of the relatively hard dental enamel material and the other materials need to be removed in order to manufacture the dental prostheses. This could not only be associated with the loss of a large quantity of the dental enamel material and the other materials, but the milling tools can also be subject to intensive use and a relatively large amount of time would be required to implement the method. A carrier structure is not provided in this method either and it has to be additionally attached to the prosthetic base, as in analog methods.

If a multi-stage process is selected in which the prosthetic teeth and/or the prosthetic base are to be manufactured from a plurality of different materials, the material consumption and thus also the time requirement and the tool load increase as a result.

Furthermore, if the dental enamel material is incompletely removed from the outer sides (the occlusal and oral side) of the prosthetic base, aesthetically troublesome white or tooth-colored residues then remain which have to be removed manually by a dental technician. This can in turn result in an undesired reduction in the material thickness of the prosthetic base.

Furthermore, a drawback of conventional methods can be that either the prosthetic teeth or the prosthetic base have to be manufactured from castable plastics materials such as PMMA-based materials. This limits the material selection.

In the prior art, there are the following options for producing digitally designed partial dental prostheses:
1. Milling or printing the gum-colored prosthetic base and adhesively bonding it to artificial prosthetic teeth, alternatively to milled or printed tooth-colored segments. Drawbacks of this can be: fabrication inaccuracy, time requirement, aesthetic challenges due to adhesive excesses or underfilling of marginal gaps, limitations regarding millability of cavities because of undercuts.
2. Milling premanufactured milling disks having an integrated dual-phase structure. This can involve an attempt to achieve natural aesthetics by skillful arrangement of the transitions. The drawback is the position of the gum-colored to tooth-colored transitions, which are always a compromise and aesthetically unsatisfactory.
3. Milling preformed moldings in which prefabricated prosthetic teeth are already integrated. Mainly, in these methods only the basal side of the partial dental prosthesis is still individually manufactured. The drawback is that the compatibility with individual patient cases is extremely limited and many variants of preformed moldings need to be kept available.
4. Layered structure of a partial dental prosthesis consisting of tooth-colored individual layers and a prosthetic base by milling and refilling the milled-out cavities multiple times. The drawbacks are the high material loss and the time requirement.

The object of the invention is to overcome at least one drawback or a plurality of drawbacks of the prior art at least in part. In particular, an option needs to be found for providing a method for producing a partial dental prosthesis, comprising a carrier structure, a partial dental prosthesis comprising a carrier structure, and a device for producing such a partial dental prosthesis comprising a carrier structure from three different and securely interconnected materials, which make it possible to produce said dental prostheses in a rapid and resource-saving manner by means of subtractive CAM methods and optionally additionally additive CAM methods. According to a first possible aspect, in the method, as little material as possible needs to be removed both from the material for the prosthetic teeth and from the material for the prosthetic base. Production can be largely performed using digital manufacturing technology. In particular, the at least three materials need to be able to be joined to one another within the method. The material should be able to be selected as freely as possible. In particular, it may be useful to avoid the prosthetic teeth and the prosthetic base from consisting completely of a cured and previously liquid plastics material. The method needs to be as easy and straightforward as possible for the dental technician to implement. In particular, where possible, fully automated or maximally automated methods such as CAD/CAM technologies need to be used and usable.

The features of independent claims 1, 13, and 14 contribute to at least partly accomplishing one of the above-mentioned objects. Dependent claims 2 to 12 and 15 provide preferred embodiments which contribute to at least partly accomplishing at least one of the objects. A method according to claim 1, a partial dental prosthesis according to claim 13, and a device according to claim 14 therefore at least make a contribution to at least partly achieving the objects. Preferred variants are claimed in dependent claims 2 to 12 and 15.

The objects of the invention are therefore achieved partly or are contributed to by a method for producing a partial dental prosthesis, the partial dental prosthesis comprising at least one prosthetic tooth, a prosthetic base, and a carrier structure, the prosthetic base comprising a gum-colored plastics material and the at least one prosthetic tooth, the prosthetic base, and the carrier structure being securely interconnected in the method, the method being characterized by the following steps:
A) digitally constructing a virtual three-dimensional model of the partial dental prosthesis with or without the carrier structure or applying an existing virtual three-dimensional model of the partial dental prosthesis with or without the carrier structure;
B1) generating a virtual three-dimensional model of the at least one prosthetic tooth, a virtual three-dimensional model of the prosthetic base, and a virtual three-dimensional model of the carrier structure on the basis of the virtual three-dimensional model of the partial dental prosthesis with the carrier structure, such that the virtual three-dimensional model of the at least one prosthetic tooth, the virtual three-dimensional model of the prosthetic base, and the virtual three-dimensional model of the carrier structure result in partial volumes of the virtual three-dimensional model of the partial dental prosthesis that are separate from one another, or
B2) generating a virtual three-dimensional model of the at least one prosthetic tooth and a virtual three-dimensional model of the prosthetic base on the basis of the virtual three-dimensional model of the partial dental prosthesis, such that the virtual three-dimensional model of the at least one prosthetic tooth and the virtual three-dimensional model of the prosthetic base result in partial volumes of the virtual three-dimensional model of the partial dental prosthesis that are separate from one another;
C1) producing the carrier structure on the basis of the virtual three-dimensional model of the carrier structure using a CAM method or
C2) producing the carrier structure using an analog method by adjusting to a physical model of the patient's oral cavity and scanning the surface of the carrier structure produced in an analog manner, and generating a virtual three-dimensional model of the carrier structure from the scan of the surface of the carrier structure produced in an analog manner, the virtual three-dimensional model of the carrier structure generated from the scan being added to the virtual three-dimensional model of the partial dental prosthesis without the carrier structure by digital processing and being subtracted in regions from the virtual three-dimensional model of the at least one prosthetic tooth or being subtracted in regions from the virtual three-dimensional model of the at least one prosthetic tooth and from the virtual three-dimensional model of the prosthetic base;
D) providing a milling body for producing the at least one prosthetic tooth, the milling body consisting of a material suitable for prosthetic teeth;
E) producing a connecting surface between the at least one prosthetic tooth and a support structure for positioning the carrier structure on one hand and the prosthetic base and the carrier structure on the other hand in a surface of the milling body by means of a subtractive CAM method in line with the virtual three-dimensional model of the at least one prosthetic tooth, the virtual three-dimensional model of the prosthetic base, and the virtual three-dimensional model of the carrier structure;
F) after step E), arranging or fastening the carrier structure on the connecting surface of the milling body;
G) after step F), introducing at least one fluid polymerizable plastics material onto regions of the connecting surface and into the volume removed in step E) in the surface of the milling body;
H) after step G), curing or partially curing the at least one fluid polymerizable plastics material, a cured plastics material resulting during the curing or a partially polymerized plastics material resulting during the partial curing, the cured plastics material or the partially polymerized plastics material interconnecting the carrier structure and the material of the milling body; and
I) after step H), subtractively machining the cured or partially polymerized plastics material and the milling body using a CAM method in line with the virtual model of an outer surface of the partial dental prosthesis, such that the partial dental prosthesis comprising the carrier structure, the cured or partially polymerized plastics material, and the material of the milling body is subtractively worked out.

After working out the partial dental prosthesis in step I), fins can also be present for fastening the partial dental prosthesis in a holder of the CAM device used. These fins can be removed in a subsequent step.

For example and according to the invention, an existing virtual three-dimensional model of the partial dental prosthesis can preferably be applied in that the CAD data of the virtual three-dimensional model of the partial dental prosthesis are input for data processing. To be input, the already existing and thus previously digitally constructed virtual three-dimensional model of the partial dental prosthesis can be uploaded remotely over the Internet, over a wireless connection such as Bluetooth, or from a data medium.

Partial dental prostheses are prostheses which replace one missing tooth or a plurality of missing teeth, but not all the teeth in a patient's oral cavity, in order to reinstate their function and aesthetic appearance. Unlike a full dental prosthesis, only some and not all of the teeth in the oral cavity are replaced. Such partial dental prostheses comprise at least one prosthetic tooth, a prosthetic base, and a carrier structure. The partial dental prosthesis according to the invention preferably consists of the at least one prosthetic tooth, the prosthetic base, and the carrier structure.

The carrier structure can merely be a holding structure, by means of which the partial dental prosthesis is fastened to existing structures such as teeth and/or implants in the oral cavity.

The carrier structure is used to fasten the partial dental prosthesis in the oral cavity and in particular to existing teeth in the patient's oral cavity. If the partial dental prosthesis consists of a plurality of parts, the carrier structure is preferably additionally used to fasten the parts of the partial dental prosthesis to one another.

The carrier structure can comprise one or more retentions, which is/are arranged inside the prosthetic base. The retentions are used to mechanically stabilize the structure of the partial dental prosthesis.

The carrier structure can comprise at least one crib, the partial dental prosthesis being able to be fastened to at least one tooth in the patient's oral cavity by the at least one crib.

The at least one fluid polymerizable plastics material being introduced onto regions of the connecting surface means that at least the regions of the connecting surface not covered by the carrier structure, i.e. the regions of the connecting surface not belonging to the support structure, with which the at least one polymerizable plastics material comes into contact, are preferably wetted by the at least one polymerizable plastics material.

The support structure is a surface which abuts a surface of the carrier structure and determines the positioning of the carrier structure relative to the at least one prosthetic tooth. In particular, this also makes it possible to introduce the at least one fluid polymerizable plastics material into the intermediate spaces. The support structure can extend directly from the at least one prosthetic tooth out of the surface, which represents a connection of the at least one prosthetic tooth to the prosthetic base. Alternatively or additionally, the support structure can also be separate from the at least one prosthetic tooth, for example in the region of a palatal plate of the partial dental prosthesis. Furthermore, it is alternatively or likewise additionally possible for the carrier structure to be supported directly by a surface of the at least one prosthetic tooth, such that the support structure is part of the surface of the at least one prosthetic tooth, preferably a part of the surface of the at least one prosthetic tooth oriented towards the prosthetic base. If the support structure is not arranged within the volume of the virtual three-dimensional model of the prosthetic base, it is part of the surface of the virtual three-dimensional model of the carrier structure. Such support structures outside the volume of the prosthetic base are completely removed in step I) (where applicable, except for fins for fastening the partial dental prosthesis in a holder of the CAM device used). In particular, when the physical partial dental prosthesis is complete, no material of the milling body for producing the at least one prosthetic tooth should remain on the carrier structure of the partial dental prosthesis in a manner isolated from the prosthetic base or in the form of a carrier structure outside the virtual three-dimensional model of the partial dental prosthesis. All the projections and fins forming the carrier structure which are not arranged completely within the volume of the prosthetic base are therefore removed in step I), provided that they are not fins for fastening the partial dental prosthesis in a holder of the CAM device used, or at the latest after step I), if they are fins for fastening the partial dental prosthesis in a holder of the CAM device used.

Therefore, the connecting surface comprises or consists of all the surfaces that are intended to connect the at least one prosthetic tooth to the prosthetic base, and the surface of the support structure that holds the carrier structure and positions it relative to the at least one prosthetic tooth in the process.

Within the meaning of the present invention, two or three separate partial volumes represent two or three parts of the volume of the three-dimensional virtual model of the partial dental prosthesis that are separate from one another and do not overlap. Separate partial volumes therefore do not have any shared volume portions.

In contrast with a digital method, an analog method for producing the carrier structure is a method in which the prosthesis is adjusted to the situation in the patient's oral cavity using manual measures and/or steps on the patient. In the present case, it is sufficient for an analog method if at least one of the method steps for producing the carrier structure proceeds in an analog manner, while other steps can also have a digital construction.

“Subtracting the virtual three-dimensional model of the carrier structure generated from the scan in regions from the virtual three-dimensional model of the at least one prosthetic tooth or from the virtual three-dimensional model of the at least one prosthetic tooth and from the virtual three-dimensional model of the prosthetic base” can be understood to mean that part of the volume of the virtual three-dimensional model of the carrier structure generated from the scan is arranged in the volume of the virtual three-dimensional model of the at least one prosthetic tooth or in the volume of the virtual three-dimensional model of the at least one prosthetic tooth and/or in the volume of the virtual three-dimensional model of the prosthetic base and is mathematically removed and therefore subtracted from the virtual three-dimensional model(s) of the at least one prosthetic tooth and/or the prosthetic base. As a result, the virtual three-dimensional model of the at least one prosthetic tooth or the virtual three-dimensional model of the at least one prosthetic tooth and the virtual three-dimensional model of the prosthetic base become smaller in volume. In the process, the virtual three-dimensional model of the at least one prosthetic tooth can comprise the support structure as part of the connecting surface for connecting the carrier structure.

The milling body can be a circular blank. The milling body can comprise a holding structure by means of which the milling body can be fastened to a device for subtractive machining using a CAM method. The device for subtractive machining using a CAM method can preferably be a computer-controlled milling machine, such as a four-axis computer-controlled milling machine or a five-axis computer-controlled milling machine. Within the meaning of the present invention, a milling body is understood to be a solid body which is suitable for subtractive machining by milling tools and of which the geometric dimensions are suitable for handling in subtractive CAM devices, such as computer-controlled CAM milling machines.

A material suitable for prosthetic teeth should be tooth-colored at least in the final state and at the same time should have the necessary hardness and appearance to be usable for prosthetic teeth. The material suitable for the prosthetic teeth is preferably a final-cured, tooth-colored plastics material, but can also be a suitable tooth-colored ceramic. Such materials for producing prosthetic teeth are known to a person skilled in the art.

It can be provided that the material for the prosthetic teeth is a plastics material or a plastics composition, preferably a polymethyl methacrylate (PMMA) or a PMMA-containing plastics composition and/or a hot polymer.

Within the meaning of the present invention, the connecting surface represents the surface at which the at least one prosthetic tooth is connected, preferably connected so as to be flush, to the prosthetic base in the partial dental prosthesis and the support structure is connected, preferably connected so as to be flush, to the carrier structure for holding the carrier structure. Particularly preferably, no clearance and/or no free volume is provided between the at least one prosthetic tooth and the prosthetic base or between the support structure and the carrier structure.

In a method according to the invention, steps A), D), E), F), G), H), and I) are necessarily carried out, whereas either step B1) or step B2) and either step C1) or step C2) need to be carried out in the method according to the invention.

The material for the at least one prosthetic tooth (i.e. the material of the milling body or at least of the part of the milling body from which the at least one prosthetic tooth is manufactured), the at least one fluid polymerizable plastics material, the gum-colored plastics material, the material from which the carrier structure is manufactured, and (if present) all the other materials from which the partial dental prosthesis is manufactured have to be biocompatible and have to be suitable and, where necessary, authorized for use in the patient's oral cavity.

In the present case, an “oral side” and an “oral surface” of the prosthetic base or the partial dental prosthesis is understood to mean the surface/side facing the oral cavity, i.e. the surface/side facing away from the contact surface on the gum.

It can be provided that the introduction of the at least one fluid polymerizable plastics material in step G) is performed by plugging and/or is carried out at an overpressure, in particular in a pressure pot or in a pressure chamber having a pressure above normal pressure, preferably at a pressure of at least 150 kPa, particularly preferably at a pressure of at least 200 kPa, most particularly preferably at a pressure of at least 200 kPa and at most 400 kPa.

It can further be provided that the curing or partial curing of the fluid polymerizable plastics material in step H) is performed under the effect of heat and/or pressure, the curing or partial curing preferably taking place over a period of between 10 minutes and 120 minutes, particularly preferably of between 30 minutes and 60 minutes.

It can also be provided that the curing or partial curing of the at least one fluid polymerizable plastics material in step H) is performed by light curing, in particular by light polymerization.

In the method according to the invention, the carrier structure can be manufactured separately from the prosthetic base and the at least one prosthetic tooth.

The carrier structure can preferably be manufactured by printing a part with subsequent burn-out or model casting or by milling from high-strength material. The carrier structure preferably consists of a metal, particularly preferably of stainless steel or titanium.

To complete the method, a surface finish can be provided by polishing and/or chemical treatment of the partial dental prosthesis.

It can be provided that the carrier structure in step F) is arranged or fastened to protrude from the machined surface of the milling body, apart from on the connecting surface or apart from on the support structure of the connecting surface of the milling body.

It can also be provided that, in step G), the at least one fluid polymerizable plastics material is applied to the milling body in regions or the milling body is surrounded by the at least one fluid polymerizable plastics material in regions or completely once the at least one fluid polymerizable plastics material has been introduced.

In step H), the cured or partially polymerized plastics material preferably results on or in the connecting surface of the milling body and with a flush connection to the connecting surface of the milling body.

It can preferably be provided that, in step I), no subtractive machining, or no significant subtractive machining, of the carrier structure is performed. However, according to the invention, parts of the carrier structure can particularly preferably be exposed in step I).

In the method according to the invention, it can be provided that generating the virtual three-dimensional model of the at least one prosthetic tooth, the virtual three-dimensional model of the prosthetic base, and the virtual three-dimensional model of the carrier structure on the basis of the virtual three-dimensional model of the partial dental prosthesis in step B1) is performed such that the virtual three-dimensional model of the at least one prosthetic tooth, the virtual three-dimensional model of the prosthetic base, and the virtual three-dimensional model of the carrier structure result in the virtual three-dimensional model of the partial dental prosthesis when combined, or generating the virtual three-dimensional model of the at least one prosthetic tooth and the virtual three-dimensional model of the prosthetic base on the basis of the virtual three-dimensional model of the partial dental prosthesis without the carrier structure in step B2) is performed such that the virtual three-dimensional model of the at least one prosthetic tooth and the virtual three-dimensional model of the prosthetic base result in the virtual three-dimensional model of the partial dental prosthesis without the carrier structure when combined.

As a result, the virtual three-dimensional model of the at least one prosthetic tooth, the virtual three-dimensional model of the prosthetic base, and optionally the virtual three-dimensional model of the carrier structure can be generated directly from the virtual three-dimensional model of the partial dental prosthesis by file splitting.

Furthermore, it can be provided that, in step B2), a virtual three-dimensional model of a carrier structure is constructed using CAD, the CAD construction taking place by applying a virtual three-dimensional model of the patient's oral cavity and by applying the virtual three-dimensional model of the partial dental prosthesis without the carrier structure, and this virtual three-dimensional model of the carrier structure constructed using CAD being used in step C1) to produce the carrier structure.

As a result, the carrier structure can be individually adjusted to the patient's individual needs.

Furthermore, it can be provided that the carrier structure consists of or is produced from a material having a greater hardness and/or elasticity than fully crosslinked PMMA and/or the carrier structure is produced from metal, ceramic, stainless steel, titanium, or a titanium alloy.

For the hardness of fully crosslinked PMMA, a ball indentation hardness in accordance with ISO 2039-1 of 195 MPa is assumed.

For the elasticity of fully crosslinked PMMA, a tensile modulus of elasticity in accordance with ISO 527 of approximately 3200 MPa is assumed and/or a tensile strength in accordance with ISO 527 of approximately 73 MPa.

According to the invention, it can be provided that the carrier structure consists of or is produced from a material having a ball indentation hardness in accordance with ISO 2039-1 of at least 195 MPa.

According to the invention, it can be provided that the carrier structure consists of or is produced from a material having a tensile strength in accordance with ISO 527 of at least 73 MPa.

This ensures that the carrier structure is suitable for carrying the entire construction of the partial dental prosthesis.

Furthermore, it can be provided that, in step I), the cured or partially polymerized plastics material is subtractively machined using a CAM method such that the carrier structure is partially exposed, or that the cured or partially polymerized plastics material and the milling body are subtractively machined using a CAM method such that the carrier structure is partially exposed.

This ensures that the carrier structure can be fastened to existing teeth in the patient's oral cavity or to other fixing points in the oral cavity.

It can also be provided that, after step G) or after step H), a step J) is performed, in which the partially polymerized plastics material undergoes final curing, in particular undergoes final curing by light polymerization, and, following steps I) and J), polishing of the surface of the partial dental prosthesis and/or surface finishing of the partial dental prosthesis is preferably carried out.

As a result, a high final strength of the final-cured plastics material and thus of the prosthetic base of the partial dental prosthesis is obtained, in particular in the connection between the prosthetic teeth and the prosthetic base and between the carrier structure, the at least one prosthetic tooth, and the prosthetic base.

According to a preferred development, it can be provided that a circumferential wall is arranged on the milling body, the circumferential wall remaining in steps D) to G), preferably, in step G), the circumferential wall coming into contact with the at least one fluid polymerizable plastics material, particularly preferably the at least one fluid polymerizable plastics material being introduced onto the connecting surface and into the volume removed in step E) in the surface of the milling body such that the level rises up to the circumferential wall, but remains below the circumferential wall.

As a result, the method is easier for the user to carry out. This reduces the risk of soiling the surroundings with the fluid polymerizable plastics material.

It can be provided that the surface of the milling body, in which the connecting surface between the prosthetic teeth and the prosthetic base is produced in step B), is a flat surface.

This later makes it easier to introduce or apply the fluid polymerizable plastics material. In addition, a commercially available blank can thus be used as a milling body.

It can also be provided that the cured plastics material or the partially polymerized plastics material has different material properties and/or a different color after the gum-colored plastics material of the prosthetic base has fully cured, the cured plastics material or the partially polymerized plastics material preferably having a hardness and/or transparency that differs from the gum-colored plastics material of the prosthetic base after said material has fully cured.

Furthermore, it can be provided that, in step G), the at least one fluid polymerizable plastics material is introduced onto the connecting surface and into the volume removed in step E) in the milling body such that the at least one fluid polymerizable plastics material connects the machined milling body to the carrier structure, the at least one fluid polymerizable plastics material preferably completely wetting the connecting surface produced in step E) in the milling body except for the points of the support structure covered by the carrier structure and/or at least the volume removed in step E) in the surface of the milling body being completely filled with the at least one fluid polymerizable plastics material, in particular without any entrapped gas.

This ensures that there is no entrapped air or gas in the partial dental prosthesis later and that there is a stable, form-fitting connection of the layers or parts of the partial dental prosthesis.

Furthermore, it can be provided that, in step I), subtractive machining of the cured or partially polymerized plastics material and the milling body is performed from the direction of the underside of the milling body, which is opposite the surface of the milling body machined in step E), using the CAM method in line with the occlusal surface and the oral surface of the virtual model of the partial dental prosthesis.

It can also be provided that, in step I), subtractive machining of the cured or partially polymerized plastics material or of the cured or partially polymerized plastics material and the milling body is performed from the direction of the surface of the milling body machined in step E), using the CAM method in line with the basal surface of the virtual model of the partial dental prosthesis.

This ensures that the respective surfaces are manufactured from the desired materials of the milling body and of the cured or partially polymerized plastics material.

It can also be provided that a cavity for receiving the fluid polymerizable plastics material is arranged on the surface of the milling body provided for machining using the subtractive CAM method, the cavity having a bottom and, starting from the edge of the bottom, the cavity being laterally delimited by a circumferential wall, the circumferential wall being annular, and the material suitable for prosthetic teeth forming the bottom and extending as far as a lower side of the milling body, which lower side is arranged to be opposite the upper side of the milling body.

This makes it easier to introduce the at least one fluid polymerizable plastics material.

Within the meaning of the present invention, an annular wall comprises a cut-out which surrounds the geometric midpoint of the cut-out. Preferably, the cut-out is formed without undercuts and/or any point in the cut-out is connectable to any other point in the cut-out by a straight line without the straight line extending within the circumferential wall. Preferably, the cut-out is a compact geometric body.

Depending on the construction, the carrier structure can directly abut the machined milling body without any spacing. This variant is preferred according to the invention because it is easier to implement.

Furthermore, it can be provided that, when generating the virtual three-dimensional model of the at least one prosthetic tooth in step B1) or B2), at least one retention of the carrier structure is provided, the at least one retention being spaced apart from the at least one prosthetic tooth and the at least one retention being surrounded by the cured plastics material after step H), the carrier structure preferably comprising at least one crib for connecting to the patient's teeth, the at least one crib being connected to the at least one retention.

This mechanically stabilizes the partial dental prosthesis. The at least one crib serves to fasten the partial dental prosthesis in the oral cavity.

Furthermore, it can be provided that, after step C1) or C2) and before step F), the carrier structure is pretreated on the surfaces that are applied to the connecting surface of the machined milling body, preferably by roughening, applying a connector, cleaning, and/or chemical etching.

This makes the connection between the carrier structure and the connecting surface of the machined milling body more stable.

It can also be provided that, during the subtractive machining of the cured or partially polymerized plastics material and the milling body in step I), an offset is provided relative to the carrier structure for spacing the tool for implementing the CAM method.

This prevents damage to the carrier structure and/or reduces the risk of damage by the tools (milling heads) of the CAM device being guided at a safety distance, predetermined by the offset, from the regions which are occupied by the carrier structure.

The objects underlying the present invention are also achieved at least in part by a partial dental prosthesis produced using an above-described method.

The objects underlying the present invention are also achieved at least in part by a device for implementing an above-described method, the device comprising:
1) a connecting-surface calculation module for calculating a connecting surface between the at least one prosthetic tooth and a support structure for positioning the carrier structure on one hand and the prosthetic base and the carrier structure on the other hand in line with a virtual three-dimensional model of a shape of the connecting surface of the at least one prosthetic tooth relative to the prosthetic base and the carrier structure in the partial dental prosthesis;
2) a connecting-surface control module for a CAM device programmed to control the subtractive production of the connecting surface calculated using the connecting-surface calculation module in a milling body; and
3) a partial-prosthesis control module for a CAM device programmed to control the subtractive production of the surface of the partial dental prosthesis to be produced in line with the virtual model of an outer surface of the partial dental prosthesis.

The device can be a controller for a CAD/CAM device by means of which partial dental prostheses can be produced, the device according to the invention being provided by suitable programming of the CAD/CAM device. A suitable CAD/CAM device known from the prior art for producing a partial dental prosthesis can thus be converted into a device according to the invention by means of a software update with suitable programming.

In this case, it can be provided that the device comprises a carrier-structure calculation module, which carries out the calculation of a carrier structure for connection to a connecting surface of the milling body to be subtractively produced, the carrier structure being able to be calculated such that it forms an application piece that fits to the connecting surface, the connecting-surface control module for a CAM device preferably being programmed to control the subtractive production of the connecting surface in the milling body calculated by the connecting-surface calculation module and the carrier-structure calculation module.

This ensures that the device is also suitable for calculating and handling the three-dimensional virtual model of the carrier structure.

In summary, the invention relates to a method for producing a partial dental prosthesis using CAD models, comprising the steps of:
generating each model of prosthetic teeth, a prosthetic base, and a carrier structure;
producing the carrier structure in a digital or analog manner;
producing a connecting surface in a milling body;
arranging the carrier structure on the connecting surface;
introducing a fluid polymerizable plastics material into the volume removed in the surface of the milling body;
curing or partially curing the plastics material; and
subtractively machining the polymerized plastics material and the milling body (6) using a CAM method.

The invention also relates to a partial dental prosthesis producing using such a method and to a device for implementing such a method.

The invention is based on the surprising findings that, using digital manufacturing techniques, it is possible to directly interconnect at least one prosthetic tooth, a prosthetic base, and a carrier structure for producing a partial dental prosthesis in accordance with a virtual three-dimensional model of the partial dental prosthesis (the model with or without carrier structure) and, in the process, to ensure time-saving and resource-saving production when implementing the production method at the same time. In this case, in a surprising manner, by calculating or producing the connecting surface with the support structure for applying or fastening the carrier structure to the machined milling body, the positioning of the carrier structure relative to the at least one prosthetic tooth and also relative to the prosthetic base can be specified and, at the same time, the three parts of the partial dental prosthesis can be directly interconnected by introducing the polymerizable plastics material for producing the prosthetic base, the connecting surface being calculated on the basis of the virtual three-dimensional models used, and optionally additionally by the virtual three-dimensional models generated as part of the method, and being generated in the milling body. In this case, the quantity of fluid polymerizable plastics material used up can be kept low. It is possible to manufacture large portions of the at least one prosthetic tooth or the entirety of the at least one prosthetic tooth from materials which do not consist of a cured and previously fluid flowable plastics material (such as a powder/liquid PMMA).

By having a geometry of the milling body that already roughly corresponds to the final dimensions, significantly reduced material consumption can be achieved. A greater range of materials can also be used, and they are no longer limited to PMMA. Milling times can also be significantly reduced owing to the reduced subtractive removal. Owing to the final surface milling only when in the connected state, the result corresponds with high accuracy to the digital database, i.e. to the virtual three-dimensional model of the partial dental prosthesis to be produced. By applying the digital production techniques, the carrier structure can also be prevented from being damaged or destroyed because, during the final surface milling, the position and location of the carrier structure is known on the basis of the virtual three-dimensional model of the carrier structure.

By means of the method according to the invention, high accuracy of fit of the partial dental prosthesis is achieved by directly milling the final shape. There is therefore no effort required for adhesively bonding individual prosthetic teeth, and no inhomogeneities arise in the partial dental prosthesis due to a joining process. At the same time, by completely curing the milling body or using a particularly hard and solid milling body, it is possible to obtain a particularly abrasion-resistant material for the at least one prosthetic tooth and, additionally, by using a layered milling body, a particularly aesthetically attractive prosthetic tooth material. In partial dental prostheses, there is a natural color transition from the gum color to the tooth color in the right places, and no compromises can be made in this respect. Particularly good aesthetics can be achieved here by using multilayer milling disks as tooth-colored solid bodies as milling bodies for the at least one prosthetic tooth.

Production from the milling body, from the cured or partially cured fluid polymerizable plastics material, with the carrier structure, and using the method according to the invention can be carried out in just a three-stage or four-stage production process. Furthermore, different shape variants of milling bodies are not required. However, a very small set of different sizes of milling blanks can also be used or can be advantageous.

Exemplary embodiments of the invention are explained below with reference to three schematic figures and one flow chart but without thereby limiting the invention. In the drawings:

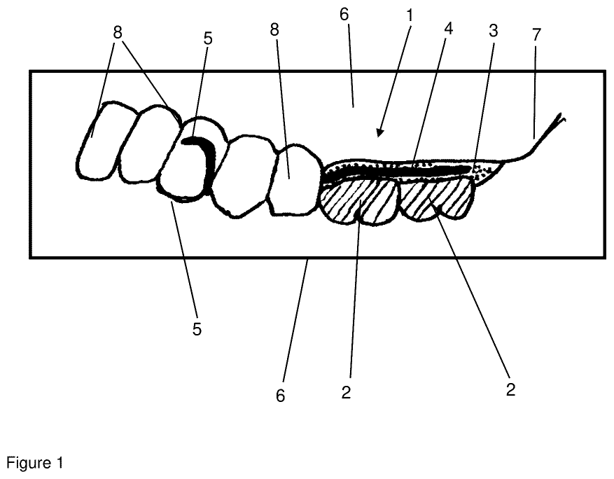

FIG. 1 is a schematic side view of a partial dental prosthesis, its arrangement in a patient's oral cavity, and the milling body, indicated as a rectangular box;

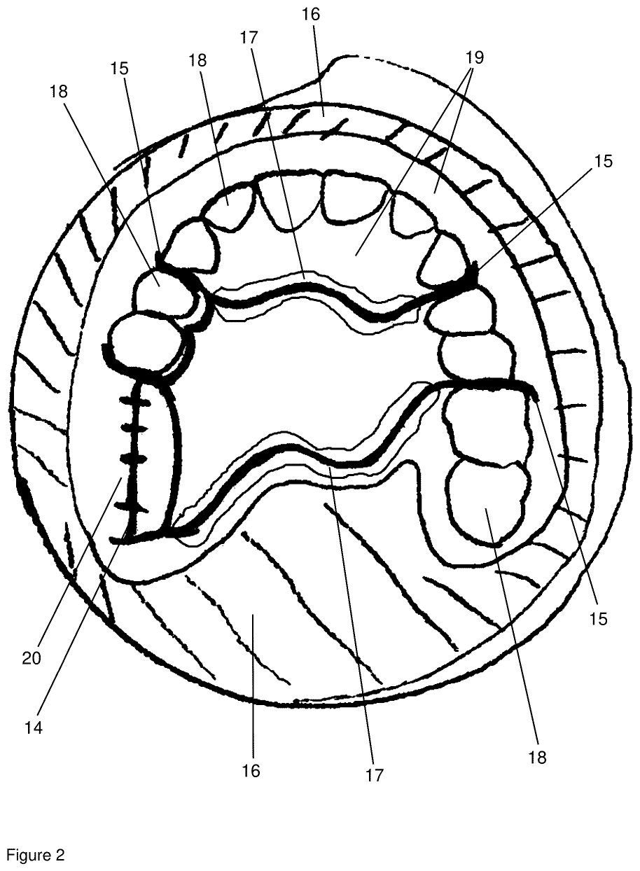

FIG. 2 is a schematic plan view of the oral side of a model of the oral cavity milled into a round milling body, comprising a connecting surface and an inserted carrier structure;

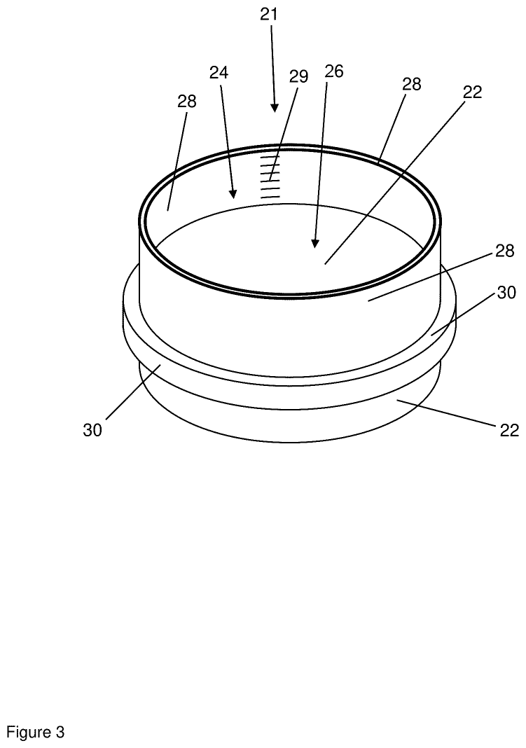

FIG. 3 is a schematic perspective view of an upper side of a milling body comprising an annular wall for implementing a method according to the invention; and

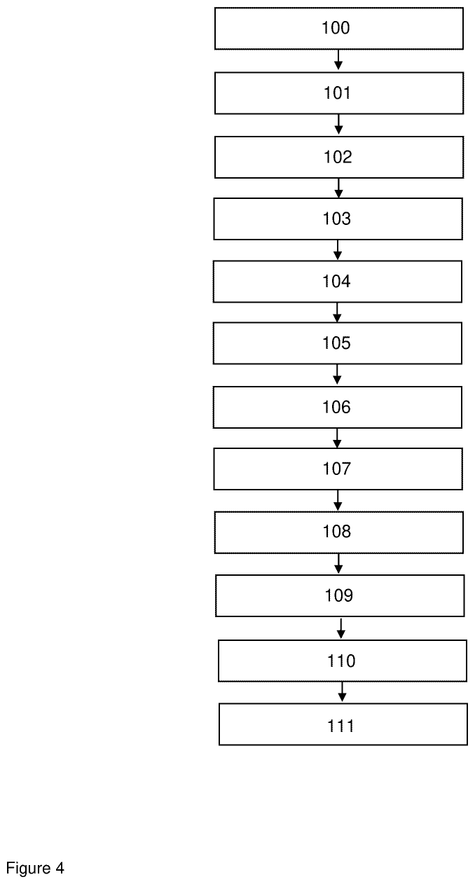

FIG. 4 shows the sequence of a method according to the invention for producing a partial dental prosthesis.

FIG. 1 is a schematic side view of a partial dental prosthesis 1 and its arrangement in a patient's oral cavity.

The partial dental prosthesis 1 comprises two prosthetic teeth 2. For a partial dental prosthesis 1 according to the invention, however, it is sufficient for it to comprise at least one prosthetic tooth. This also does not have to be two adjacent molars, as shown in FIG. 1, but it can replace any one or more teeth. The at least one prosthetic tooth 2 is manufactured from a milling body 6, which is indicated in FIG. 1 as a rectangular box and indicates the location of the at least one prosthetic tooth 2 in the milling body 6. The milling body 6 can consist of a tooth-colored plastics material that is as hard as possible.

The partial dental prosthesis 1 further comprises a prosthetic base 3. The prosthetic base 3 is manufactured from a gum-colored plastics material, which was introduced into the partially milled-out milling body 6 as a fluid polymerizable plastics material and was cured or partially cured therein before the prosthetic base 3 was produced therefrom using a subtractive CAM method. The partial dental prosthesis 1 further comprises a carrier structure 4, 5. The carrier structure 4, 5 can comprise a retention 4 and a crib 5. The retention 4 of the carrier structure 4, 5 can be located within the prosthetic base 3. The crib 5 is located outside the prosthetic base 3.

In FIG. 1, the partial dental prosthesis 1 rests on an alveolar ridge 7 in the patient's oral cavity by the prosthetic base 3. The carrier structure 4, 5 can be fastened to at least one tooth 8 in the patient's oral cavity by the crib 5. The teeth 8, the alveolar ridge 7, and the milling body 6 are not part of the partial dental prosthesis 1.

FIG. 2 is a schematic plan view of the oral side of a model of a part of the oral cavity milled into a round milling body 16, comprising a connecting surface 20 in the milling body 16 and an inserted carrier structure 14, 15. The carrier structure 14, 15 can comprise a retention 14 and a crib 15. The connecting surface 20 is generated on the basis of a transition between at least one prosthetic tooth and a prosthetic base (not shown in FIG. 2) and the carrier structure 14, 15 is generated on the basis of a virtual three-dimensional model of the at least one prosthetic tooth and a virtual three-dimensional model of the prosthetic base. The virtual three-dimensional model of the at least one prosthetic tooth and the virtual three-dimensional model of the prosthetic base can be computationally generated from a virtual three-dimensional model of the partial dental prosthesis by means of file splitting. In addition to the contact surfaces between the at least one prosthetic tooth and the prosthetic base, the connecting surface 20 also comprises a support structure 17, which is provided for connecting the machined milling body 16 to the carrier structure 14, 15 and for holding and positioning the carrier structure 14, 15 against the machined milling body 16. In the present case, the support structure 17 supports the carrier structure 14, 15 in a surface below a palatal plate, which is particularly preferred according to the invention. It is, however, also possible for the support structure 17 to support the carrier structure 14, 15 only at individual points, preferably at least three points. As a result, clear positioning and orientation of the carrier structure 14, 15 against the connecting surface 20 is ensured. The transition between the at least one prosthetic tooth on one hand and the prosthetic base and the carrier structure on the other hand is generated in the milling body 16 on the basis of the virtual models using a CAM method. In addition, a model 19 of part of the patient's oral cavity can be generated in the milling body 16 in order to fasten the cribs 15 to the teeth 18 in the model. The contact surfaces between the cribs 15 and the teeth 18 are also part of the support structure 17 and can thus be understood to be part of the connecting surface 20.

The carrier structure 14, 15 can then simply be placed or positioned on the connecting surface 20, in particular on the support structure 17. In this situation, a fluid polymerizable plastics material can be cast into the cavity milled into the milling body 16 in the region of the connecting surface 20 and can be cured or partially cured there in order to provide the material for the prosthetic base.

The partial dental prosthesis can then be milled out on the milling body 16, the carrier structure 14, 15, and the fully or partially cured plastics material using a CAM method. The virtual three-dimensional model of the partial dental prosthesis can be used for this purpose. The fluid polymerizable plastics material can lastly undergo final curing during partial curing.

FIG. 3 is a schematic perspective view of an upper side (at the top in FIG. 3) of a milling body 21 for implementing a method according to the invention. The milling body 21 comprises a solid body 22 made of a first material or the milling body 21 can consist of the solid body 22. The solid body 22 extends as far as a lower side opposite the upper side of the milling body 21 (not visible in FIG. 3). The first material can be a fully polymerized tooth-colored plastics material, which is suitable for producing prosthetic teeth and has the required abrasion resistance for this purpose. The first material preferably already needs to be biocompatible, as is the case for the milling body 21, in order to be suitable for applications in a patient's oral cavity.

A cavity 24 having a bottom 26 is arranged on the upper side of the milling body 21, the cavity 24 being laterally delimited by a circumferential wall 28. The bottom 26 is (preferably completely) formed by the solid body 22. The circumferential wall 28 can consist of the first material or of another material. In particular, the circumferential wall 28 can be an annular body or a tube piece, which is placed onto the solid body 22 and securely connected thereto. The connection can be made by adhesive bonding. The solid body 22 can be cylindrical in shape.

The solid body 22 can comprise a shoulder on the outer circumference for placing on an annular body or tube piece as the circumferential wall 28, onto which shoulder the annular body or the tube piece is placed so as to be flush. The circumferential wall 28 can in particular be a cylindrical tube piece. The circumferential wall 82 can also be a metal annular body. The milling body 21 is subtractively machined on the bottom 26 on the upper side of the milling body 21, in order to produce the connecting surface (not shown in FIG. 3) between the at least one prosthetic tooth (not shown) on one hand and the prosthetic base and the carrier structure (not shown) on the other hand.

A marker 29 for determining a fill level in the cavity 24 can be arranged on an inner side of the circumferential wall 28 facing the cavity 24. The marker 29 can, however, also be applied to, for example milled into, the circumferential wall 28 only during a method for producing the partial dental prosthesis. On the basis of the marker 29, the fluid polymerizable plastics material (not shown in FIG. 3) to be introduced into the cavity 24 can be introduced up to the correct height.

At least one holder 30 for fixing the milling body 21 in a CAM device can be arranged on at least one outer side of the milling body 21. The holder 30 can project from the outer wall of the milling body 21 in the form of a placed-on torus having a rectangular cross-sectional area.

As an alternative to the holder 30 shown in FIG. 3, the holder 30 can also be produced in another way, for example by means of protruding projections or by means of indentations in the side surfaces. The holder 30 is used for fastening in a CAM device (not shown).

The milling body 21 according to FIG. 3 can be used as follows in a method according to the invention. The milling body 21 is fixed in a subtractive CAM device, such as a computer-controlled multi-axis milling machine, by means of the holder 30. By means of a virtual CAD model of a partial dental prosthesis to be generated, a surface is generated in the bottom 26, which corresponds to the connecting surface between the first material and the carrier structure as well as the cured plastics material to be produced from the fluid polymerizable plastics material in line with the virtual CAD model. In addition, the occlusal or oral surfaces of the surfaces (of the later prosthetic base) consisting of the cured plastics material are worked out of the solid body 22 as a negative shape using the subtractive CAM device. An offset can be used here such that the negative shape is worked somewhat deeper, preferably at least a few tens of a millimeter deeper, into the solid body 22 than the occlusal or oral surface would require for the cured plastics material according to the CAD model for a direct negative shape. In addition, the marker 29 can be generated on the circumferential wall 28 only in this step. The thus newly generated surface in the bottom 26 of the solid body 22 can then be cleaned.

A carrier structure can be generated on the basis of a CAD model (for example by 3D printing from metal) or it can be manufactured in an analog manner by means of an impression and scanning a model of the oral cavity or by means of a working model of the oral cavity generated by an impression. The carrier structure, similarly to that shown in FIG. 2, can be fastened to the connecting surface on the subtractively machined solid body 22. The fluid polymerizable plastics material (not shown) can then be introduced into the cavity 24 and specifically up to a height that is sufficient for the prosthetic base of the partial dental prosthesis consisting of the cured plastics material to be completely worked out of the cured plastics material on the basal side according to the virtual CAD model. The fluid polymerizable plastics material can cure under the effect of pressure and temperature and forms the cured plastics material. The intermediate product can then be fastened in the subtractive CAM device again and the partial dental prosthesis is worked out by means of the CAM device on the basis of the occlusal or oral surfaces and the basal surfaces of the virtual CAD model of the partial dental prosthesis. The prosthetic tooth or prosthetic teeth of the partial dental prosthesis then consists/consist of the first material of the milling body, the carrier structure of the partial dental prosthesis consists of the material from which it was manufactured before being inserted into the machined milling body, and the prosthetic base of the partial dental prosthesis then consists of the cured plastics material.

An exemplary method is explained below with reference to the intermediate products and end products shown in FIGS. 1 to 3. The sequence of the exemplary method is shown schematically in FIG. 4.

In a first processing step 100, a virtual three-dimensional model of the partial dental prosthesis 1 to be generated is calculated using CAD. The virtual three-dimensional model of the partial dental prosthesis 1 to be generated can comprise a carrier structure 4, 5, 14, 15, but does not have to comprise a carrier structure.

In a subsequent second processing step 101, the virtual three-dimensional model of the partial dental prosthesis 1 is calculated, for example by file splitting, into a tooth portion as the virtual three-dimensional model of the at least one prosthetic tooth 2 and a prosthetic base portion as the virtual three-dimensional model of the prosthetic base 3. In addition, a virtual three-dimensional model of the carrier structure 4, 5, 14, 15 can also be calculated if the virtual three-dimensional model of the partial dental prosthesis 1 comprises one.

In a third processing step 102, a physical carrier structure 4, 5, 14, 15 can be generated on the basis of the virtual three-dimensional model of the carrier structure 4, 5, 14, 15 or the physical carrier structure 4, 5, 14, 15 is produced in an analog manner and is then scanned to generate a virtual three-dimensional model of the carrier structure 4, 5, 14, 15, the surface of the virtual three-dimensional model of the at least one prosthetic tooth 2 being modified by the virtual three-dimensional model of the carrier structure 4, 5, 14, 15. In the same way, the virtual three-dimensional model of the prosthetic base 3 can also be adjusted by the virtual three-dimensional model of the carrier structure 4, 5, 14, 15.

In a fourth processing step 103, the connecting surface 20 between the at least one prosthetic tooth 2 and the support structure 17 is calculated for positioning the carrier structure 4, 5, 14, 15 on one hand and the prosthetic base 3 and the carrier structure 4, 5, 14, 15 of the partial dental prosthesis 1 on the other hand in the virtual three-dimensional model. In addition, calculation is performed of the surface 19 to be produced in a milling body 6, 16 comprising the connecting surface 20 having the support structure 17, optionally having a separate holder structure for the support structure 17, for example in the form of protruding fins, for applying the carrier structure 4, 5, 14, 15 using CAD methods.

In a fifth processing step 104, a fitting physical milling body 6, 16 is provided and is fastened in a CAM device.

On the basis of the virtual models generated in the second and fourth processing steps, and optionally also in the third processing step, the surface 19, 20 to be produced is produced in a milling body surface in the milling body 6, 16 in a sixth processing step 105 using a subtractive CAM method. In this case, the connecting surface 20 is generated using the CAM method. In this case, a cavity is produced in the surface of the milling body 6, 16.

In a seventh processing step 106, the carrier structure 4, 5, 14, 15, produced in an analog manner or using a CAM method, is applied or fastened to the machined surface 19, 20 of the milling body 6, 16.

In a subsequent eighth processing step 107, a fluid polymerizable plastics material is introduced or pushed into the cavity.

In a ninth processing step 108, the fluid polymerizable plastics material is cured or partially cured and the machined milling body 6, 16 is thus securely connected to the carrier structure 4, 5, 14, 15.

In a tenth processing step 109, the partial dental prosthesis 1 is subtractively worked out of the composite generated in the ninth processing step 108.

Optionally, post-curing or final curing of the partial dental prosthesis 1 can then be performed in an eleventh processing step 110.

In an optional twelfth processing step 111, final machining of the partial dental prosthesis 1 can be performed, for example by surface finishing and/or polishing the partial dental prosthesis 1.

The features of the invention disclosed in the above description, as well as in the claims, drawings and exemplary embodiments, may be essential both individually and in any desired combination to realizing the invention in its various embodiments.

### LIST OF REFERENCE SIGNS

1 Partial dental prosthesis
2 Prosthetic tooth
3 Prosthetic base
4, 14 Carrier structure (retention)
5, 15 Carrier structure (crib)
6, 16 Milling body
7 Alveolar ridge in the oral cavity
8 Tooth in the oral cavity
17 Support structure
18 Tooth in the model
19 Model of the oral cavity
20 Connecting surface
21 Milling body
22 Solid body
24 Cavity
26 Bottom
28 Wall
29 Marker
30 Holder
100 Processing step: Calculating a virtual 3D model of a partial dental prosthesis
101 Processing step: Calculating virtual 3D models of prosthetic teeth and prosthetic base, optionally with carrier structure
102 Processing step: Producing the carrier structure and optionally generating a virtual 3D model of the carrier structure
103 Processing step: Calculating the surface to be produced in a milling body, comprising the connecting surface, using CAD methods
104 Processing step: Providing the milling body
105 Processing step: Producing the connecting surface and a cavity in the milling body using a subtractive CAM method
106 Processing step: Applying or fastening the carrier structure to the machined milling body
107 Processing step: Introducing fluid polymerizable plastics material into the cavity in the milling body
108 Processing step: Curing the fluid polymerizable plastics material
109 Processing step: Subtractively working out the partial dental prosthesis using a CAM method
110 Optional processing step: Post-curing or final curing of the partial dental prosthesis
111 Optional processing step: Final machining of the partial dental prosthesis

1. A method for producing a partial dental prosthesis, the partial dental prosthesis comprising at least one prosthetic tooth, a prosthetic base, and a carrier structure the prosthetic base comprising a gum-colored plastic material and the at least one prosthetic tooth, the prosthetic base, and the carrier structure being securely interconnected in the method, the method comprising the following steps:
A) digitally constructing a virtual three-dimensional model of the partial dental prosthesis with or without the carrier structure or applying an existing virtual three-dimensional model of the partial dental prosthesis with or without the carrier structure
B1) generating a virtual three-dimensional model of the at least one prosthetic tooth (2), a virtual three-dimensional model of the prosthetic base, and a virtual three-dimensional model of the carrier structure on the basis of the virtual three-dimensional model of the partial dental prosthesis with the carrier structure such that the virtual three-dimensional model of the at least one prosthetic tooth, the virtual three-dimensional model of the prosthetic base, and the virtual three-dimensional model of the carrier structure result in partial volumes of the virtual three-dimensional model of the partial dental prosthesis with the carrier structure that are separate from one another, or
B2) generating a virtual three-dimensional model of the at least one prosthetic tooth and a virtual three-dimensional model of the prosthetic base on the basis of the virtual three-dimensional model of the partial dental prosthesis without the carrier structure such that the virtual three-dimensional model of the at least one prosthetic tooth (2) and the virtual three-dimensional model of the prosthetic base result in partial volumes of the virtual three-dimensional model of the partial dental prosthesis without the carrier structure that are separate from one another;
C1) producing the carrier structure on the basis of the virtual three-dimensional model of the carrier structure using a CAM method or
C2) producing the carrier structure using an analog method by adjusting to the patient or by adjusting to a physical model of the patient's oral cavity and scanning the surface of the carrier structure produced in an analog manner, and generating a virtual three-dimensional model of the carrier structure from the scan of the surface of the carrier structure produced in an analog manner, the virtual three-dimensional model of the carrier structure generated from the scan being added to the virtual three-dimensional model of the partial dental prosthesis without the carrier structure by digital processing and a virtual three-dimensional model of the partial dental prosthesis with the carrier structure thus being generated, and the virtual three-dimensional model of the carrier structure generated from the scan being subtracted in regions from the virtual three-dimensional model of the at least one prosthetic tooth by digital processing or being subtracted in regions from the virtual three-dimensional model of the at least one prosthetic tooth and in regions from the virtual three-dimensional model of the prosthetic base
D) providing a milling body for producing the at least one prosthetic tooth, the milling body consisting of a material suitable for prosthetic teeth;
E) producing a connecting surface between the at least one prosthetic tooth and a support structure for positioning the carrier structure on one hand and the prosthetic base and the carrier structure on the other hand in a surface of the milling body by means of a subtractive CAM method in line with the virtual three-dimensional model of the at least one prosthetic tooth, the virtual three-dimensional model of the prosthetic base and the virtual three-dimensional model of the carrier structure;
F) after step E), arranging or fastening the carrier structure on the connecting surface of the milling body;
G) after step F), introducing at least one fluid polymerizable plastic material onto regions of the connecting surface and into the volume removed in step E) in the surface of the milling body;
H) after step G), curing or partially curing the at least one fluid polymerizable plastic material, a cured plastic material resulting during the curing or a partially polymerized plastic material resulting during the partial curing, the cured plastic material or the partially polymerized plastic material interconnecting the carrier structure and the material of the milling body; and
I) after step H), subtractively machining the cured or partially polymerized plastic material and the milling body using a CAM method in line with the virtual model of an outer surface of the partial dental prosthesis, such that the partial dental prosthesis comprising the carrier structure, the cured or partially polymerized plastic material, and the material of the milling body is subtractively worked out.

2. The method according to claim 1, comprising:
generating the virtual three-dimensional model of the at least one prosthetic tooth, the virtual three-dimensional model of the prosthetic base, and the virtual three-dimensional model of the carrier structure on the basis of the virtual three-dimensional model of the partial dental prosthesis in step B1) is performed such that the virtual three-dimensional model of the at least one prosthetic tooth, the virtual three-dimensional model of the prosthetic base, and the virtual three-dimensional model of the carrier structure result in the virtual three-dimensional model of the partial dental prosthesis when combined, or
generating the virtual three-dimensional model of the at least one prosthetic tooth and the virtual three-dimensional model of the prosthetic base on the basis of the virtual three-dimensional model of the partial dental prosthesis without the carrier structure in step is performed such that the virtual three-dimensional model of the at least one prosthetic tooth and the virtual three-dimensional model of the prosthetic base result in the virtual three-dimensional model of the partial dental prosthesis without the carrier structure when combined.

3. The method according to claim 1, wherein:
in step B2), a virtual three-dimensional model of a carrier structure is constructed using CAD, the CAD construction taking place by applying a virtual three-dimensional model of the patient's oral cavity and by applying the virtual three-dimensional model of the partial dental prosthesis without the carrier structure, and this virtual three-dimensional model of the carrier structure constructed using CAD being used in step C1) to produce the carrier structure.

4. The method according to claim 1, wherein:
the carrier structure consists of or is produced from a material having a greater hardness and/or elasticity than fully crosslinked PMMA and/or
the carrier structure is produced from metal, ceramic, stainless steel, titanium, or a titanium alloy.

5. The method according to claim 1, wherein:
in step I), the cured or partially polymerized plastic material is subtractively machined using a CAM method such that the carrier structure is partially exposed or
in step 1), the cured or partially polymerized plastic material and the milling body are subtractively machined using a CAM method such that the carrier structure is partially exposed.

6. The method according to claim 1, wherein:
after step G) or after step H), a step J) is performed in which the partially polymerized plastic material undergoes final curing, in particular undergoes final curing by light polymerization, and, following steps I) and J), polishing of the surface of the partial dental prosthesis and/or surface finishing of the partial dental prosthesis is preferably carried out.

7. The method according to claim 1, wherein:
a circumferential wall is arranged on the milling body the circumferential wall remaining in steps D) to G), preferably, in step G), the circumferential wall coming into contact with the at least one fluid polymerizable plastic material, particularly preferably the at least one fluid polymerizable plastic material being introduced onto the connecting surface and into the volume removed in step E) in the surface of the milling body such that the level rises up to the circumferential wall, but remains below the circumferential wall.

8. The method according to claim 1, wherein:
in step G), the at least one fluid polymerizable plastic material is introduced onto the connecting surface and into the volume removed in step E) in the milling body such that the at least one fluid polymerizable plastic material connects the machined milling body to the carrier structure the at least one fluid polymerizable plastic material preferably completely wetting the connecting surface produced in step E) in the milling body except for the points of the support structure covered by the carrier structure and/or at least the volume removed in step E) in the surface of the milling body being completely filled with the at least one fluid polymerizable plastic material, in particular without any entrapped gas.

9. The method according to claim 1, wherein:
in step 1), subtractive machining of the cured or partially polymerized plastic material and the milling body is performed from the direction of the underside of the milling body which is opposite the surface of the milling body machined in step E), using the CAM method in line with the occlusal surface and the oral surface of the virtual model of the partial dental prosthesis and/or
in step 1), subtractive machining of the cured or partially polymerized plastic material or of the cured or partially polymerized plastic material and the milling body is performed from the direction of the surface of the milling body machined in step E), using the CAM method in line with the basal surface of the virtual model of the partial dental prosthesis (1).

10. The method according claim 1, wherein:
when generating the virtual three-dimensional model of the at least one prosthetic tooth in step B1) or B2), at least one retention of the carrier structure is provided, the at least one retention being spaced apart from the at least one prosthetic tooth and the at least one retention being surrounded by the cured plastic material after step H), the carrier structure preferably comprising at least one crib for connecting to the patient's teeth (8), the at least one crib being connected to the at least one retention.

11. The method according to claim 1, wherein:
after step C1) or C2) and before step F), the carrier structure is pretreated on the surfaces that are applied to the connecting surface (20) of the machined milling body, preferably by roughening, applying a connector, cleaning, and/or chemical etching.

12. The method according to claim 1, wherein:
during the subtractive machining of the cured or partially polymerized plastic material and the milling body in step I), an offset is provided relative to the carrier structure for spacing the tool for implementing the CAM method.

13. A partial dental prosthesis produced using a method according to claim 1.

14. A device for implementing a method according to claim 1, the device comprising:
a connecting-surface calculation module for calculating a connecting surface between the at least one prosthetic tooth and a support structure for positioning the carrier structure on one hand and the prosthetic base and the carrier structure on the other hand in line with a virtual three-dimensional model of a shape of the connecting surface of the at least one prosthetic tooth relative to the prosthetic base and the carrier structure in the partial dental prosthesis;
a connecting-surface control module for a CAM device programmed to control the subtractive production of the connecting surface calculated using the connecting-surface calculation module in a milling body; and
a partial-prosthesis control module for a CAM device programmed to control the subtractive production of the surface of the partial dental prosthesis to be produced in line with the virtual model of an outer surface of the partial dental prosthesis.

15. The device according to claim 14, the device comprising a carrier-structure calculation module, which carries out the calculation of a carrier structure for connection to a connecting surface of the milling body, to be subtractively produced, the carrier structure being able to be calculated such that it forms an application piece that fits to the connecting surface, the connecting-surface control module for a CAM device preferably being programmed to control the subtractive production of the connecting surface in the milling body calculated by the connecting-surface calculation module and the carrier-structure calculation module.
